(19) United States
(12) Patent Application Publication
(10) Pub. No.: US 2005/0255828 A1
(43) Pub. Date: Nov. 17, 2005

(54) Remote terminal unit and remote monitoring and control system

(75) Inventor: Jeffrey L. Fisher, Austin, TX (US)

Correspondence Address: THE CULBERTSON GROUP, P.C., 1114 LOST CREEK BLVD., SUITE 420, AUSTIN, TX, 78746, US

(73) Assignee: Critical Wireless Corporation, Austin, TX (US)

(21) Appl. No.: 11/120,721

(22) Filed: May 3, 2005

Related U.S. Application Data
(60) Provisional application No. 60/567,629, filed on May 3, 2004.

(51) Int. Cl. H04M 11/00

(52) U.S. Cl. 455/406

(57) ABSTRACT

A remote monitoring and alerting system includes one or more remote terminal units and a central system, with both the central system and each remote terminal unit adapted to send and receive data across a communications network. Each remote terminal unit includes a processor and wireless transmitter in a compact arrangement that allows the unit to be placed conveniently in a housing associated with some remote device to be monitored. The central system includes a data collection and manipulation controller for receiving, processing, and storing data received from each remote terminal unit across the communications network. Both a user messaging controller and a user interface controller are also included in the central system. The user messaging controller transmits user messages through a suitable interface to one or more user designated devices in response to a remote terminal unit message received from the remote terminal unit. The user interface controller provides a user interface between a user of the remote monitoring and alerting system and the central system.

### CROSS-REFERENCE TO RELATED APPLICATION

This application is related to U.S. provisional patent application No. 60/567,629, filed May 3, 2004, entitled “REMOTE TERMINAL UNIT AND REMOTE MONITORING AND CONTROL SYSTEM,” the entire content of which is hereby incorporated herein by this reference. The Applicant hereby claims the benefit of this provisional application under 35 U.S.C. §119(e).

### TECHNICAL FIELD OF THE INVENTION

The invention relates to systems for remotely monitoring and controlling devices and for distributing alarms or notifications based on events at the remotely monitored devices.

### BACKGROUND OF THE INVENTION

Numerous types of equipment are adapted to operate in an automated fashion without any local operator. Some of these types of equipment may operate in remote locations. Commercial agricultural irrigation systems such as pivot irrigation systems are examples of complex automated systems that are commonly located at some remote location. These types of irrigation systems include numerous components such as motors, pumps, and conduit networks that all cooperate under a suitable automated control system to provide the desired irrigation.

It is critical to a successful agricultural operation that the automated irrigation systems used in the operation operate properly when and as intended. A failure of an automated irrigation system may deprive a crop of water at a critical time and cause severe damage to the crop. Thus, it is important that an automated irrigation system be closely monitored to ensure proper operation. Numerous other types of automated system must also be closely monitored in order to ensure proper operation and to allow corrective action to be taken in the event of some failure.

### SUMMARY OF THE INVENTION

The present invention is directed to a remote monitoring device that is used in a remote monitoring system to allow numerous different types of devices, particularly devices located at remote or widely spaced apart locations, to be easily monitored for proper operation or readily controlled from a remote location. The invention encompasses a remote monitoring and control system and a remote terminal unit for use in such a system. The invention also encompasses methods employed in a remote monitoring and control system and in the remote terminal units used in such systems.

One preferred form of remote terminal unit according to the present invention includes a substantially planar main circuit substrate and a substantially planar wireless transceiver unit. A processor and a terminal block component are both mounted on the main circuit substrate. An offset interface is connected between the main circuit substrate and the wireless transceiver unit and positions the main circuit substrate with respect to the wireless transceiver unit. In this connected position, the main circuit substrate extends along a plane substantially parallel to the plane of the wireless transceiver unit and is separated from the plane of the wireless transceiver unit by an offset distance. A battery arrangement is mounted on the remote terminal unit with a major surface of the battery arrangement substantially abutting a major surface of the wireless transceiver unit and having a first end surface adjacent to an end of the main circuit substrate. Among other benefits, this arrangement of components in the remote terminal unit provides a very compact structure that ordinarily may be housed easily within a housing of some device or system to be monitored.

The processor, preferably operating under the control of suitable operational program code, functions to receive a transmission dictating signal derived from a signal applied to a monitored input which may be associated with the terminal block. In response to the transmission dictating signal, the processor directs the wireless transceiver to transmit a remote terminal unit message. The processor may also function to receive a control signal that has been transmitted to the wireless transmitter and respond to the control signal by directing a corresponding control output to the device being monitored.

In further preferred forms of the remote terminal unit, the unit includes a serial interface such as an RS-232, RS-485, or other standard serial interface. In these forms of the invention, the processor may also function to drive a configuration interface on a standard terminal emulator in communication with the remote terminal unit through the serial interface. This configuration interface allows a user to easily configure the remote terminal unit. In yet other forms of the invention, the processor or a separate processor may implement a telemetry controller for responding to a plain text telemetry control protocol.

A remote monitoring and alerting system embodying the principles of the invention includes one or more remote terminal units and a central system, with both the central system and each remote terminal unit adapted to send and receive data across a communications network. The central system further includes a data collection and manipulation controller for receiving, processing, and storing data received from each remote terminal unit across the communications network, and both a user messaging controller and a user interface controller. The user messaging controller transmits user messages through a suitable interface to one or more user designated devices in response to a remote terminal unit message received from the remote terminal unit. The user interface controller provides a user interface between a user of the remote monitoring and alerting system and the central system.

One preferred method of operating a remote equipment monitoring system according to the present invention includes enabling a remote terminal unit to send or receive a predefined number of messages between the remote terminal unit and a central system. After enabling the remote terminal unit, the method includes monitoring the number of messages sent or received by the remote terminal unit. In response to the remote terminal unit sending or receiving some number of messages over the predefined number of messages, the method includes charging a user of the remote terminal unit a renewal charge. In this preferred method of operating the remote equipment monitoring system, the central system may be configured by the user or otherwise to send an unlimited number of user messages based upon a respective message received at the central system from the remote terminal unit.

These and other advantages and features of the invention will be apparent from the following description of the preferred embodiments, considered along with the accompanying drawings.

### BRIEF DESCRIPTION OF THE DRAWINGS

FIG. 1 is a high level diagrammatic representation of a remote monitoring and control system embodying the principles of the present invention.

FIG. 2A is a more detailed diagrammatic representation of a portion of the system shown in FIG. 1 that is located generally at the device to be monitored.

FIG. 2B is a more detailed diagrammatic representation of the portions of the system shown in FIG. 1 that are not generally located at the device to be monitored.

FIG. 3 is a diagrammatic representation of a remote terminal unit that may be used in the system shown in FIG. 1.

FIG. 4 is a block diagram showing program architecture employed at the remote terminal unit shown in FIG. 3.

FIG. 5A is an electrical schematic diagram showing an AC signal monitoring and power input arrangement according to one preferred form of the present invention.

FIG. 5B is an electrical schematic diagram showing an AC signal monitoring arrangement according to another preferred form of the invention.

FIG. 6 is a view in perspective of a remote monitoring unit according to one preferred form of the invention.

FIG. 7 is an exploded view in perspective of the remote monitoring unit shown in FIG. 6.

FIG. 8 is a side elevation view of the remote monitoring unit shown in FIG. 6.

FIG. 9 is a block diagram illustrating one preferred method of operating a remote monitoring and control system according to the present invention.

### DESCRIPTION OF PREFERRED EMBODIMENTS

The claims at the end of this application set out novel features which the Applicant believes are characteristic of the invention. The various advantages and features of the invention together with preferred modes of use of the invention will best be understood by reference to the following description of illustrative embodiments read in conjunction with the drawings introduced above.

A remote monitoring and alerting system 100 includes one or more remote terminal units 101 and a central system 102. Each remote terminal unit or RTU 101 is adapted to be connected to some device 103 to be monitored or controlled remotely through system 100. Central system 102 is adapted to communicate with the various RTUs 101 through a separate communications system, preferably including a wireless to Internet communication arrangement 104 and the Internet 105. Central system 102 is also adapted to provide a web-based user interface to system 100 that a user may access through a suitable web browser 106 executed at a user computer having Internet access. Alarms initiated from the RTUs 101 and data from the RTUs are communicated from the central system 102 through various outside communications systems 107 to user devices 108 such as telephones and pagers and through the Internet 105 to user devices such as telephones, text messaging devices, email boxes, and fax machines.

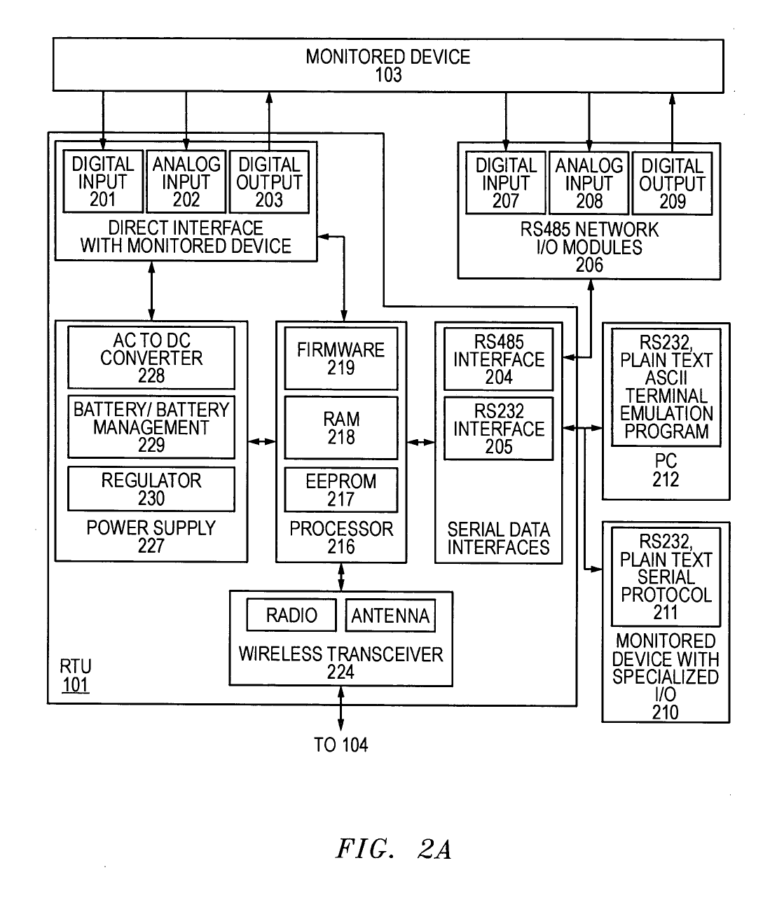

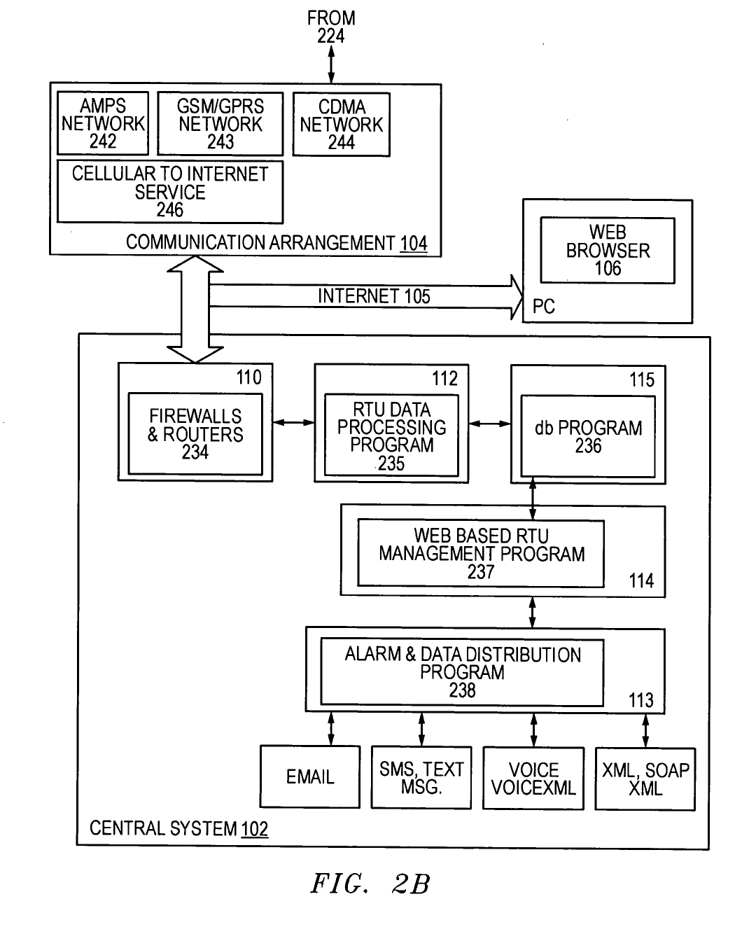

Each RTU 101 includes one or more monitored device inputs and preferably one or more outputs to the monitored device 103. As indicated in FIG. 2A, a preferred form of RTU 101 may include one or more digital inputs 201, one or more analog inputs 202, and one or more digital outputs 203 representing a direct electronic input/output interface with the equipment or devices 103 being monitored. The inputs and outputs may be to relays, dry contacts, level sensors, pressure sensors, solenoids, thermometers, valves, switches, or any other type of component that might be monitored or controlled on the monitored device 103.

Each RTU 101 preferably includes at least one standard serial communications interface such as an RS-485 interface 204 and/or RS-232 interface 205. These standard interfaces may be used to receive inputs and send outputs to input/output modules 206 that are external to the RTU 101. The example external input/output module 206 is shown as including inputs such as digital input 207 and analog input 208, and outputs such as digital output 209 to the monitored device 103. A standard serial interface such as 204 or 205 in FIG. 2 may also be used to receive RTU telemetry protocol instructions from monitored device 210 that may have specialized input/output requirements and a matching standard serial interface 211. The RTU telemetry protocol is preferably a plain text protocol as will be described further below. A standard serial interface such as 204 or 205 in FIG. 2 may also be used to receive configuration instructions for configuring the RTU 101. Configuration instructions may be directed to RTU 101 through a suitable processing device 212 such as a personal computer having a matching standard serial interface. As will be discussed further below, the configuration instructions may be entered through a suitable terminal emulation program available on the external processing device such as a personal computer 212, and the terminal emulation program may be driven by a plain text, menu-driven configuration program onboard RTU 101.

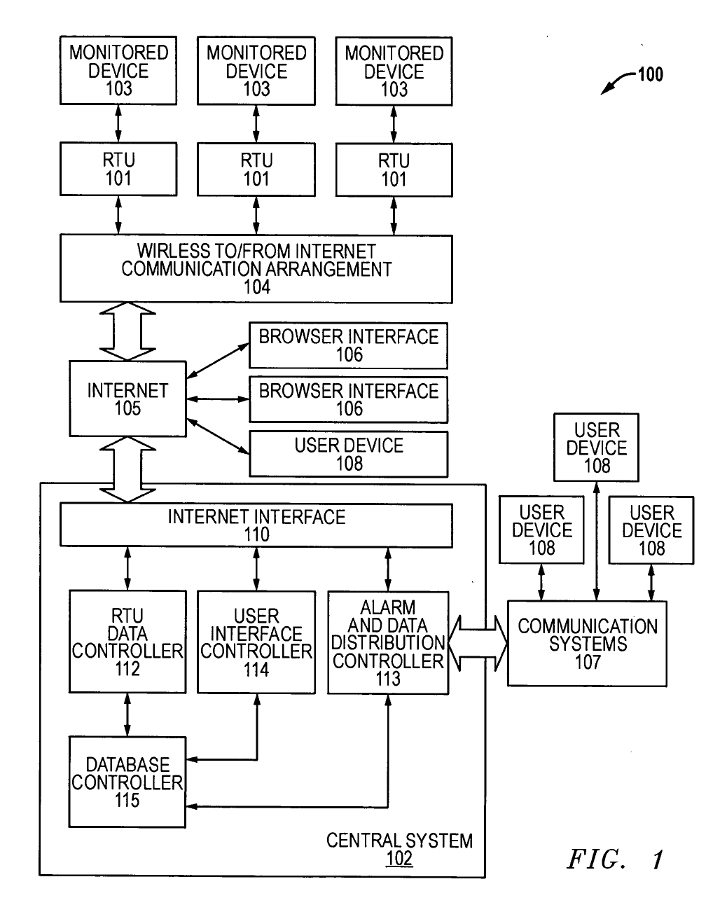

Each RTU 101 includes a processor 216 shown in FIG. 2A and associated memory, preferably EEPROM memory 217 in addition to RAM memory 218 and ROM or EPROM for storing firmware 219. EEPROM 217 is preferably used for storing non-volatile, device-specific configuration information such as serial numbers and the number of prepaid messages remaining available for RTU 101. As indicated in FIG. 2A, processor 216 receives properly conditioned inputs from inputs such as digital input 201 and analog input 202, and may drive the signals at one or more outputs such as digital output 203. Processor 216 also sends and receives information through the various standard serial interfaces that may be included in RTU 101 such as RS-485 interface 204 and RS-232 interface 205. A wireless transceiver 224 is also connected to communicate with processor 216 to provide a wireless communication network interface for RTU 101. In particular, processor 216 executes program code to direct wireless transceiver 224 to send information which is ultimately communicated to central system 102, shown in both FIGS. 1 and 2B. Transceiver 224 also receives information from central system 102 as will be discussed further below.

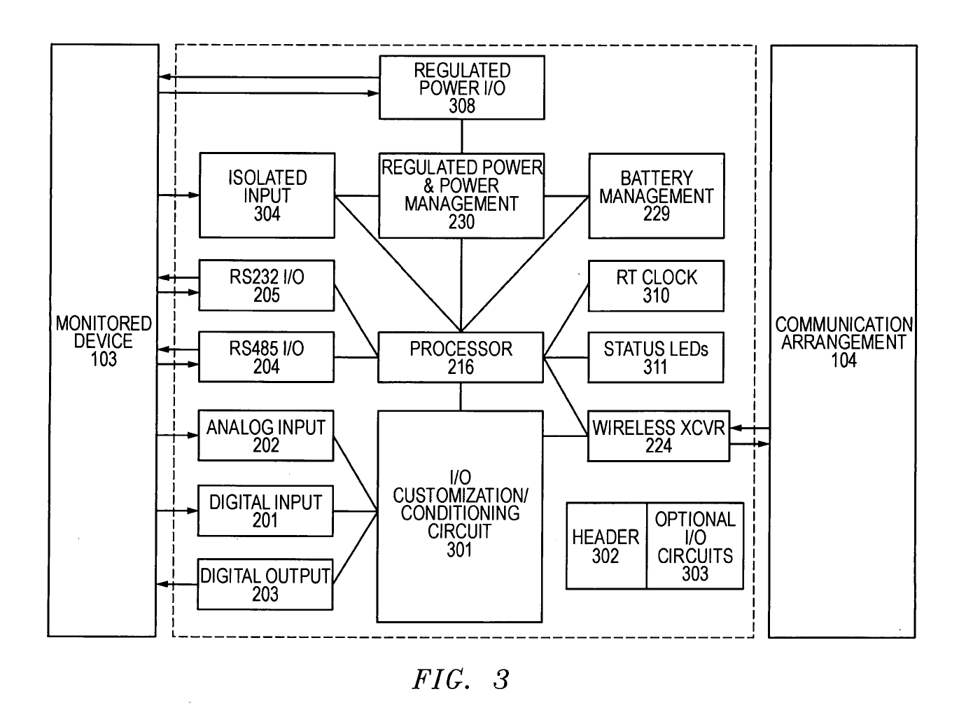

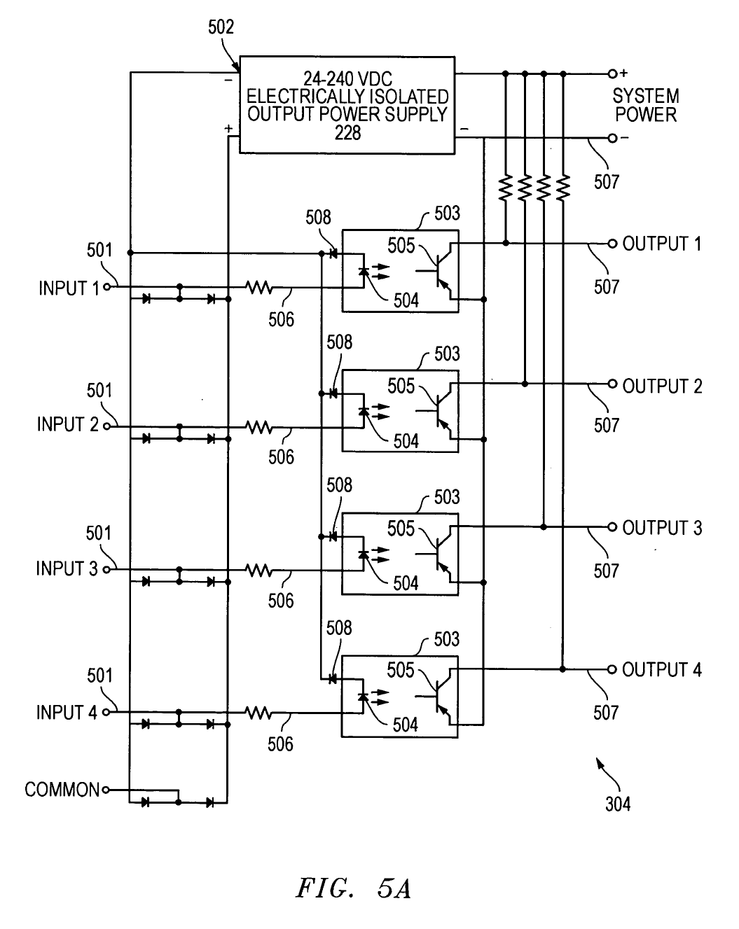

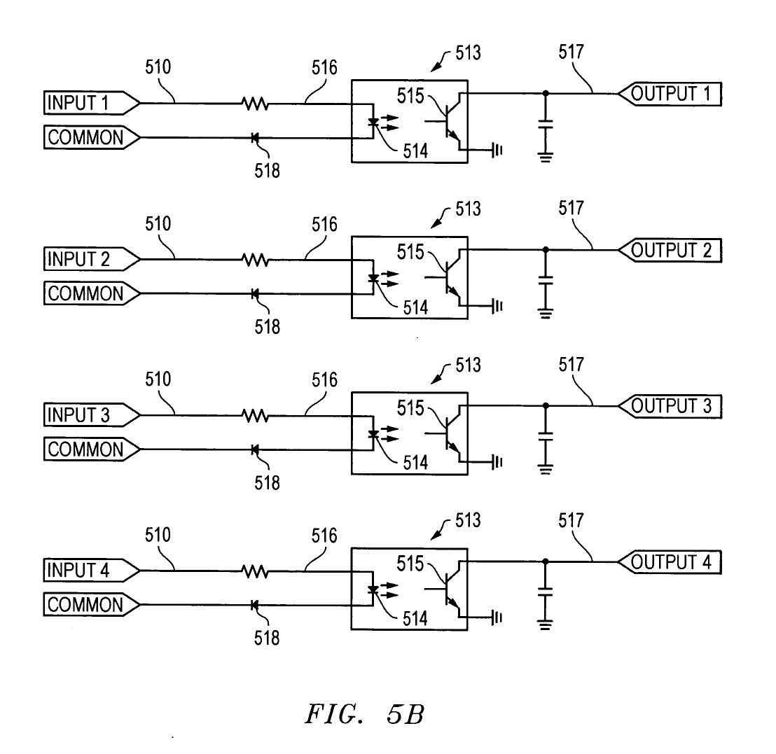

Each RTU 101 includes a power supply arrangement 227 that preferably includes a high voltage step down AC to DC converter 228, a battery or series of batteries together with a battery management/charging circuit (together labeled in FIG. 2A with reference numeral 229), and a voltage regulator 230. It will be noted from FIG. 2A that the power supply arrangement is shown connected to the direct input/output interface to the monitored device. This reflects the fact that power for the RTU 101 is preferably ultimately supplied from power available at the monitored device 103, either AC power or regulated DC power as will be described further below with reference to FIGS. 3 and 5.

Processor 216 preferably implements a telemetry controller for responding to a plain text telemetry control protocol. The plain text telemetry control protocol may be included in the firmware 219 associated with processor 216 and allow RTU 101 to respond to simple, plain text commands issued from an external device and received at the RTU through one of the standard serial interfaces that may be available on the RTU.

Processor 216 also preferably implements a configuration controller for producing a plain text configuration user interface. Operational program code for the configuration controller may be contained in firmware 219 and may be executed to drive a suitable terminal emulator at an external device such as computer 212. The configuration controller preferably drives the external terminal emulator over one of the standard serial communications interfaces available on RTU 101.

Referring to FIG. 1, central system 102 includes a system interface 110 to the communications network through which monitoring information is received from RTUs 101. Central system 102 also includes a number of controllers or functional units that are implemented by one or more processing devices or computer systems. In particular, central system 102 includes an RTU data collection and manipulation controller (RTU data controller) 112, a user messaging controller (alarm and data distribution controller) 113, and a user interface controller 114. These controllers 112, 113, and 114 may be associated with one or more database controllers 115 for handling the data used by the controllers. RTU data controller 112 receives, processes, and stores data received from each RTU through system interface 110. Controller 112 is also preferably capable of transmitting control signals to each RTU 101 through the system interface 110 in order to provide remote control capabilities for the monitored device and each RTU. User messaging controller 113 transmits user messages through system interface 110 and potentially the separate communications system 107 to one or more user designated devices in response to a remote terminal unit message received from an RTU 101. User interface controller 114 provides a user interface, preferably an Internet-based user interface, between a user of the remote monitoring and alerting system and central system 102 to allow the user to manage RTU data, configure an RTU, and configure how alarms and data are distributed through user messaging controller 113.

FIG. 2B shows further details of central system 102. In particular, FIG. 2B indicates that the system interface 110 includes firewalls and routers 234 for handling communications between central system 102 and the Internet 105. Routers are used to implement redundancy schemes in system 102 while firewalls are used to provide security. RTU data controller 112 is implemented with RTU data processing program code 235 which interacts with databases implemented through suitable database program code 236. Web based RTU management program code 237 is used to implement management controller 114, and alarm and data distribution program code 238 is used to implement alarm and data distribution controller 113. As indicated in FIG. 2, alarm and data distribution may be in a number of different formats. For example, alarms and data from an RTU 101 may be distributed using Internet communications such as email, SMS, text messaging, XML, SOAP XML, voice voice XML, or fax. These types of communications are handled through system interface 110. Alarms and data may also be distributed from central system 102 using SMS or some other text messaging protocol, telephone-addressed pagers, or by simulated voice messages over a telephone system.

FIG. 2 also indicates certain options available in the wireless to Internet communications arrangement 104 that may be used in the present system. Communications arrangement 104 may use AMPS cellular networks 242, GSM/GRPS cellular networks 243, and/or CDMA cellular networks 244, combined with a suitable service 246 to convert the cellular communication originating from RTU 101 to an Internet communication and to convert an Internet communication originating from central system 102 to a cellular communication for transmission to the respective RTU.

The web browser interface 106 to central system 102 may be used in connection with the user interface controller 114 to configure alarm or message distribution from central system 102 based on conditions monitored by one or more RTUs 101. Web browser interface 106 may also be used in connection with user interface controller 114 to allow a user to retrieve data on monitored device transmitted by one or more RTUs 101 and to issue instructions to perform various remote control operations that may be available at the monitored device 103 through outputs provided by the RTU.

The schematic diagram of FIG. 3 provides further details on a preferred form of RTU 101 for use in monitoring a remote device 103 according to the present invention. RTU 101 includes at least one monitored input and preferably a number of digital inputs 201, a number of analog inputs 202, and a number of digital outputs 203. Inputs 201 and 202 and outputs 203 are preferably connected to processor 216 on the RTU through an input/output conditioning and customization circuit 301 which may be associated with an expansion header 302 through which optional input/output circuitry 303 may be included in the RTU. A number of AC inputs associated with a fail-safe electrically isolated input arrangement 304 are also preferably available for monitoring AC signals used in monitored device 103.

RTU further includes at least one standard serial interface such as RS-485 interface 204 and/or RS-232 interface 205. The functions of these interfaces are described above with reference to FIG. 2A. It will be noted that although each standard serial interface 204 and 205 is shown as representing an input/output arrangement separate from the digital inputs 201 and digital outputs 203, some forms of the invention may implement a standard serial interface through circuitry included in optional circuitry 303. In this case some of the digital inputs and outputs would be taken up for the standard serial interface.

Wireless transceiver 224 is connected to processor 216 and adapted to transmit and receive information through a suitable communications arrangement 104 as discussed with reference to FIG. 2B. Any suitable transmission technique may be used according to the invention. A preferred transmission technique employs dual tone modulated frequency (DTMF) transmissions on a suitable cellular system control channel.

Processor 216 is operatively connected to each standard serial interface 204 and 205, the wireless transceiver 224, and to each monitored input including the digital inputs 201 and analog inputs 202, and each input associated with circuit 304. Processor 216 receives a transmission dictating signal derived from a signal applied to at least one monitored input and directs wireless transceiver 224 to transmit a message from the RTU 101 (that is, a remote terminal unit message) in response to the transmission dictating signal. The transmission dictating signal may simply be a digital signal passed on from a digital input 201 to processor 216 through circuit 301. Alternatively, the transmission dictating signal may be a conditioned or converted signal that circuit 301 produces through a received digital input 201 or analog input 202. For example, a digital signal received at an input 201 may be at a voltage level incompatible with processor 216 and circuit 301 may condition the digital signal to an appropriate voltage level for the processor. As another example, circuit 301 may convert an analog signal to a representative digital signal that may be used as a transmission dictating signal.

The illustrated preferred RTU 101 shown in FIG. 3 shows the connections between power regulator and power management circuit 230 and processor 216, as well as the connection between circuit 230 and isolated input circuit 304 and battery and battery management/charging circuit 229. It will be appreciated that the management and charging circuit included at 229 is responsible for maintaining the charge on the battery included in RTU 101 when the RTU is connected to an operative outside power source and for applying power from the battery included at 229 as necessary for the proper functioning of the RTU. In particular, power from the battery included at 229 may be required to fully power wireless transceiver 224 during transmissions. This may be true even when RTU 101 is receiving power from an outside source due to the sizing of the step down converter 228 shown in FIG. 2A, and described further below.

In preferred forms of RTU 101, a receptacle, connector, or other input/output arrangement 308 is included on the unit for enabling regulated power to be received by the unit or to be supplied by the unit. There may be instances in which the device being monitored 103 uses a suitable regulated power supply that may provide regulated power to RTU. In these cases it may be convenient just to receive the regulated power at input/output 308. Also, where RTU 101 is being powered through an AC output from monitored device 103 or from some other source, or where the RTU is temporarily being powered through the battery included at 229, input/output 308 may be used to output regulated power to the monitored device or perhaps to other devices such as a remote networked input/output module 206 shown in FIG. 2A.

FIG. 3 shows that a preferred RTU 101 includes a real time clock 310 in communication with processor 216. Real time clock 310 provides real time information to processor 216 for use in generating data to be transmitted to the central system 102 shown in FIGS. 1 and 2, and for other purposes at RTU 101. FIG. 3 also shows that an RTU 101 according to the invention may also include a status indicating arrangement 311. One preferred status indicating arrangement 311 includes a number of LEDs that may be activated to indicate that RTU 101 is operating properly, or activated to provide other status indications.

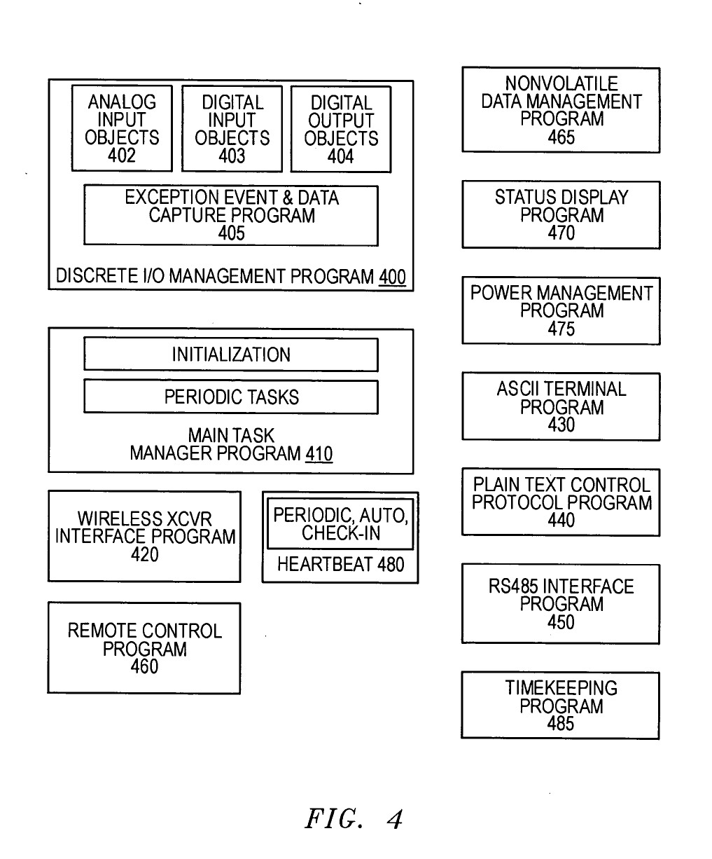

FIG. 4 illustrates one preferred arrangement of operational program code employed at RTU 101, and preferably stored as firmware. This firmware was shown initially at 219 in FIG. 2A. The operational program code used by RTU 101 and executed by processor 216 to control the various functions and operations of the RTU may be broken down into a number of different functional blocks shown in FIG. 4.

One functional block of program code comprises discrete input/output management program code 400. Input/output management program code 400 includes analog input objects 402, digital input objects 403, and digital output objects 404, together with exception event and periodic data capture processing code 405. Analog input objects 402 include analog-to-digital conversion program code, calibration constants, and look up tables. Digital input objects 403 include signal filtering program code, timers, and counters and accumulators. Digital output objects 404 include timers, and counters and accumulators. All of the program code included in input/output management program code 400 is executed by processor 216 (FIGS. 2 and 3) to receive and process analog and digital inputs received at the RTU 101 from monitored device (103 in FIGS. 1-3) so that appropriate actions may be taken in response to the inputs. The program code 400 also processes signals that are output to the monitored device.

Another functional block is the main task manager program code shown at 410 in FIG. 4. This main task manager program code 410 includes initialization program code for initializing the various components of RTU 101, and periodic task program code for periodically conducting tasks associated with inputs to the RTU, power management tasks, tasks associated with the serial protocols that may be used by RTU 101, and tasks associated with terminal emulation as will be described further below.

Wireless transceiver interface program code 420 in FIG. 4 comprises another function block of program code included in preferred forms of RTU 101. This program code 420 includes code for forming wireless data transmissions and message queuing, along with program code for wireless network compliance. Wireless transceiver interface program code 420 also includes program code for implementing a round-robin dynamic peripheral payload manager and for facilitating data and protocol conversion.

Reference numeral 430 in FIG. 4 shows ASCII terminal program code or configuration making up another function block of program code in preferred forms of the invention. This configuration program code 430 includes code for implementing a plain text menu to allow a user to configure the RTU 101 through a suitable terminal emulator. Configuration program code 430 also includes additional related program code for status and display diagnostics, settings and configuration, and testing.

One particularly beneficial feature of preferred forms of the present RTU 101 is that system users may send a plain text instructions to the RTU through a standard serial interface such as the RS-232 interface 405 shown in FIGS. 2A and 3. In order to provide this functionality, the program code associated with RTU 101 includes a plain text control protocol program code. This plain text control protocol program code is shown as another function block at 440 in FIG. 4. This program code 440 includes program code to facilitate incoming instruction parsing, alarm input enumeration or identification, obtaining signal status data, and variable size data payloads in outgoing messages from RTU 101 to the central system shown in FIGS. 1 and 2B. The signal status data feature facilitates the use of a command that may be received via the RS-232 plain text protocol to query the RTU 101 for the status of its inputs. The variable size data payload feature allows the user to cause RTU 101 to send a signal or message that has associated with it a payload of data, such as data regarding the operation of the monitored device 103. The user may choose the data payload size to be a size sufficient to contain the amount of data that is desired to be sent with the message.

Another feature that is particularly useful in preferred forms of RTU 101 is a standard serial interface for enabling the RTU to receive inputs and direct outputs from a remote input/output module such as module 206 shown in FIG. 2A. To implement this functionality, the program code executed at RTU 101 includes RS-485 interface program code 450 as another functional block in the code used to control the RTU. This program code is executed by processor 216 (FIGS. 2A and 3) to process inputs received over the RS-485 interface and to direct outputs to monitored device through the RS-485 interface.

The program to code executed at RTU 101 may further include a number of other functional blocks that facilitate various operations. In particular, FIG. 4 shows that RTU 101 includes remote control program code 460, nonvolatile data management program code 465, status display management program code 470, power management program code 475, periodic check-in or heartbeat program code 480, and timekeeping program code 485.

FIG. 5A shows a preferred isolated input arrangement 304 shown in block form in FIG. 3. In this preferred embodiment the voltage step down convertor/power supply 228, originally described with reference to FIG. 2A is included in the isolated input arrangement 304. The isolated input arrangement 304 shown in FIG. 5A includes four separate monitored AC signal inputs 501 connected to an input 502 of power supply 228. A separate isolating device 503 is associated with each respective monitored AC signal input 501. In the illustrated example circuit, each isolating device 503 comprises an opto-isolator having a LED 504 and a light sensing transistor 505. The node 506 associated with each respective isolating device 503 represents an input to the device. Each respective monitored AC signal input 501 is coupled to the power supply input 502 through the LED 504 of the respective isolating device 503. Thus, the AC signal at an input 501 is applied as an input to the respective isolating device 503. The output DC signal from power supply 228 is applied to the emitter of the transistor 505 of each respective isolating device 503 and the collector of each respective transistor is connected to a respective signal output 507. Thus, when activated, each isolating device 503 is connected to apply a signal at the level of the DC output from power supply 228 at the respective signal output 507.

Since each AC input 501 is connected to the input terminal of power supply 228, any monitored AC signal within the operating range of the power supply applied at an input 501 represents a power input to the RTU 101 (FIGS. 1, 2A, and 3). Power supply circuit 228 rectifies the AC input and steps the voltage level down to a suitable level for the RTU, preferably around 12 volts. The output from power supply 228 is then applied to the power regulation and management circuit 230 shown in FIGS. 2A and 3 and used to power the processing elements of the RTU 101 and the battery management/charging circuit included at element 229. Simultaneously, the signal at output 507 in FIG. 5A for the respective monitored AC input 501 is applied as a monitored signal to processor 216. Processor 216 may monitor this half-wave rectified signal under the control of the operational program code and cause wireless transceiver 224 to generate outgoing messages in response to certain changes in the respective signal. It is noted that since any of the AC inputs may be relatively high voltage inputs, 120 volts AC for example, a separate diode may be required to prevent exceeding the breakdown voltage of the respective LED 504. These separate diodes are shown at 508 in FIG. 5A.

FIG. 5B shows an alternative isolated input arrangement that may be used in some preferred forms of the remote terminal unit according to the present invention. The isolated input arrangement shown in FIG. 5B may be used particularly when an onboard/internal power supply, such as power supply 228, is not included in the remote terminal unit. In versions of the remote terminal unit that does not include such an internal power supply, the device will rely on an external power source for supplying power to the processing elements of the RTU and the battery management/charging circuit such as that shown at 229 in FIGS. 2A and 3. Of course, when relying on such an external power supply an RTU would not include a regulated power input/output as indicated at 308 in FIG. 3, but only a regulated power input connection for receiving power from an external source. This external power source will still commonly be associated with the device being monitored.

The arrangement shown in FIG. 5B includes four separate monitored AC signal inputs 510, each connected to a respective isolating device 513. In the illustrated example circuit, each isolating device 513 comprises an opto-isolator having a LED 514 and a light sensing transistor 515. The respective node 516 associated with each respective isolating device 513 represents an input to the isolating device. A respective diode 518 is included with each isolating device to provide a higher break down level than the respective LED 514 and prevent current flow between the common cathodes associated with the inputs 510. Unlike the circuit shown in FIG. 5A, each respective monitored AC signal input 510 is simply applied to the respective isolating device and is not applied to any AC/DC converter, power supply. The respective transistor 515 has its collector terminal coupled to a respective output 517. These outputs 517 are each connected to a respective input to the RTU processor (216 in FIGS. 2A and 3) and are normally maintained at a logically high voltage level in this embodiment. However, when an appropriate AC input is applied at a respective input 510, the respective transistor 515 is placed in a conductive state, allowing the voltage level on the respective output 517 to drop to a logically low level for half of the AC input signal cycle. The processor may monitor the logical state of the respective output 517 under the control of the operational program code and cause the wireless transceiver associated with the RTU (224 in FIGS. 2A and 3) to generate outgoing messages in response to certain changes in the respective signal.

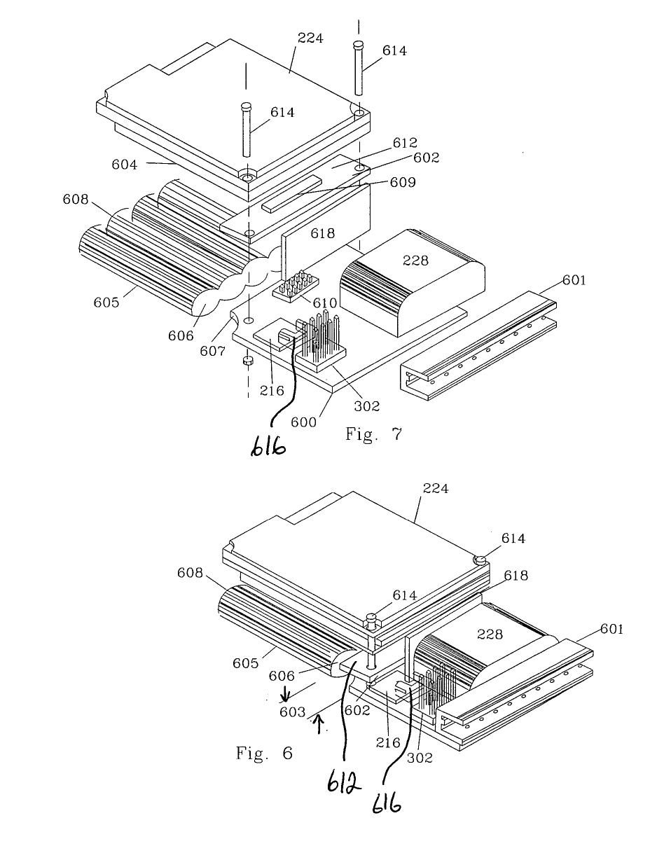

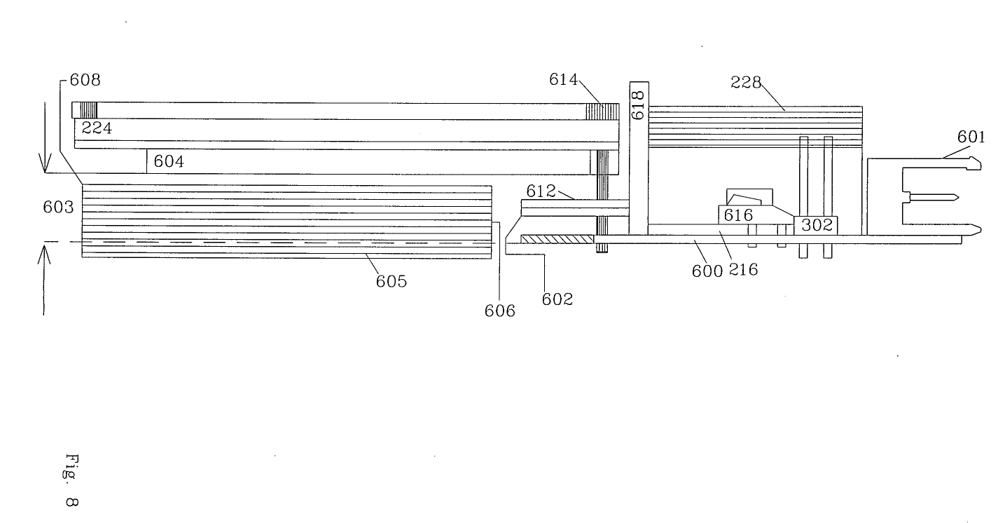

The present invention also includes a unique layout for the various components of the RTU 101 illustrated schematically in FIGS. 1 through 4. This unique layout and arrangement of components is illustrated in FIGS. 6 and 7. The compact arrangement shown in the figures provides a great deal of flexibility in the manner in which RTU 101 may be deployed. One important benefit of the compact design is that the RTU is sufficiently small to allow it to be housed in protected areas such as waterproof control boxes at the monitored device (103 in FIGS. 1, 2A, and 3). This obviates the need for a waterproof housing for the RTU itself.

Referring now to FIGS. 6 and 7, RTU 101 includes a substantially planar main circuit substrate or circuit board 600 on which is mounted the RTU processor 216, power supply 228, and a terminal block component 601. The terminal block component 601 provides terminal contacts for the various inputs and outputs associated with RTU 101. An offset interface 602 is connected between main circuit substrate 600 and the substantially planar wireless transceiver 224. This offset interface positions main circuit substrate 600 with respect to wireless transceiver 224 so that the main circuit substrate extends along a plane substantially parallel to the plane of the wireless transceiver with an offset distance 603 separating a lower major surface 604 of the wireless transceiver and the plane of the main circuit substrate. This offset 603 allows battery arrangement 605 to be placed with a first end surface 606 adjacent to an end 607 of the main circuit substrate and with an upper major surface 608 substantially abutting lower major surface 604 of the wireless transceiver. This offset between wireless transceiver 224 and substrate 600 and the positioning of battery arrangement 605 facilitates a very small footprint for RTU 101.

Another advantage of offset interface 602 is that it allows the basic RTU structure to accommodate substantially any type of transceiver arranged in a substantially planar form regardless of the particular connector used by the transceiver. That is, transceiver manufactures may use different connector pin arrangements or may frequently change connector pin arrangements. A change in the transceiver pin arrangement, and thus the socket required to connect to the transceiver, would require a modification to the main circuit substrate if the transceiver were connected directly to substrate 600. With the offset interface 602, however, only the upper connector 609 (FIG. 7) of the offset interface must be changed to accommodate a different connector for the transceiver. The lower connector (not shown) associated with offset interface 602 may remain the same to connect with substrate-mounted connector 610 which may also remain the same for different types of transceivers with different connector arrangements.

The preferred offset interface 602 shown in FIGS. 6 through 8 includes a ground plane 612 that preferably extends substantially the entire width of transceiver 224 and substrate 600. This ground plane 612 extends generally parallel to the plane of wireless transceiver 224 and the plane of main circuit substrate 600 at a position between the transceiver and main circuit substrate. Ground plane 612 helps block electromagnetic radiation emanating from circuit elements on substrate 600 that could interfere with the proper operation of transceiver 224.

First and second connecting devices 614 fasten wireless transceiver 224 to main circuit substrate 600 with offset interface 602 sandwiched there between. The first and second connecting devices 614 are preferably located on opposite lateral sides of offset interface 602, wireless transceiver 224, and main circuit substrate 600, in order to securely hold the components in the desired connected position shown in FIGS. 6 and 8. Although threaded bolts and corresponding nuts are shown for the connecting devices 614 in the figures, it will be appreciated that many alternative connecting devices may be used. For example, clips (not shown) on opposite lateral sides of substrate 600 may be used to clip a transceiver in the position shown in FIGS. 6 and 8.

FIGS. 6 through 8 also show the expansion header 302 first described above with reference to FIG. 3. Expansion header 302 is mounted on main circuit substrate 600. The expansion header is operatively coupled between processor 216 and the input/output terminals or pins available on terminal block component 601. As mentioned above, header 302 may be used to attach optional input/output circuitry 303 (not shown in FIGS. 6 through 8) to the RTU. The optional circuitry may, for example, implement a standard serial interface such as an RS-232 or RS-485 interface, or may enable RTU 101 to receive and process a particular type of output from the monitored device 103 shown in FIGS. 1 through 3. For example, the monitored device 103 may include a thermocouple that produces a thermocouple output. In this example, optional circuitry connected to RTU 101 through header 302 may allow the RTU to receive the thermocouple output directly through one of the analog inputs 202 (FIGS. 2 and 3) and condition the signal to a digital representation suitable for input to processor 216.

Another feature of the preferred layout shown in FIGS. 6 through 8 is a battery connector 616 mounted on main circuit substrate 600 with a portion extending over a major surface of processor 216 opposite the surface of the processor that faces the main circuit substrate. This battery connector position makes efficient use of space on substrate 600 and helps reduce the overall footprint of RTU 101.

Another component of RTU 101 that is illustrated in FIGS. 6 through 8 is a light pipe arrangement 618. This light pipe arrangement 618 extends from status LEDs (not shown in FIGS. 6 through 8) mounted on substrate 600 to a lens or opening on a housing (also not shown) for RTU 101. The status LEDs are illustrated in diagrammatic form at 311 in FIG. 3.

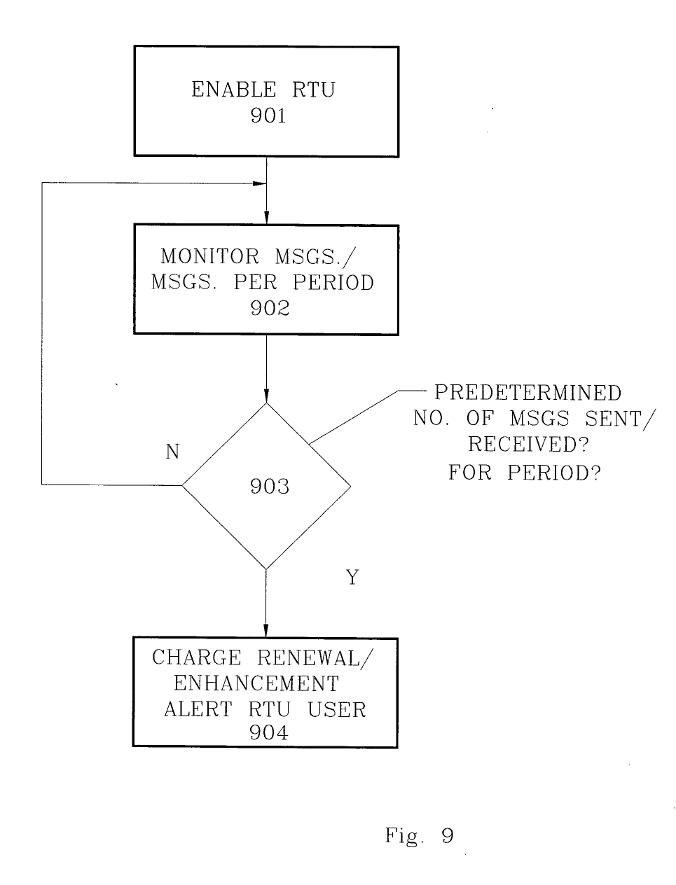

The present invention also includes a method of operating remote equipment monitoring system 100, the method includes enabling RTU 101 to send a predefined number of messages to central system 102 or receive a predefined number of messages from the central system as indicated at block 901 in FIG. 9. Enabling RTU 101 to send or receive a predefined number of messages may be accomplished by a system operator through the user interface capability provided through user interface controller 114 shown in FIG. 1. With RTU 101 enabled, the method also includes monitoring the number of messages sent and/or received by the RTU as shown at block 902. The central system 102 shown in FIG. 1 may monitor the number of messages sent or received by RTU 101 through the RTU data controller 112 and database controller 115 also shown in FIG. 1. If RTU 101 sends or receives some number of messages over the predefined number of messages as indicated at decision block 903, the method includes responding to the overage by charging a user of the RTU a renewal charge. This charging step is shown at block 904 in FIG. 9. The method may further or alternatively include advising the RTU user that renewal will be necessary when the RTU 101 sends or receives some number of messages approaching the predefined number or charging the RTU user a renewal charge at that time. The RTU user may be advised of the approaching limit through one or more of the notification routes for alarm distribution through central system 102. If the RTU user does not submit the renewal fee in a timely fashion, the RTU may be disabled from sending or receiving messages by instruction from central system 102, and the RTU user may be notified of the action preferably through one or more of the notification routes available for alarms as described above with reference to FIGS. 1 through 3.

In preferred methods for operating remote equipment monitoring system 100 an unlimited number of user messages may be transmitted from central system 102 based on messages received by central system from an enabled RTU 101. That is, the charge to the RTU user is not based on the number of alarms that the user may configure the system to send in response to a given message from the RTU 101. Rather, the charge to the user is based on messages or traffic to and from RTU 101 and any charge associated with purchasing or leasing the RTU.

In some preferred forms of operating remote equipment monitoring system 100, the number of messages to and/or from RTU 101 may be limited to some predefined number over some predefined period of time and monitored either with or without the total number of messages at block 902. The method of operating system 100 may then include charging the RTU user an enhancement charge in response to the remote control unit sending or receiving more than a predetermined number of remote terminal unit messages over a predefined period as indicated at block 904. Again, system 100 may be configured to send the RTU user notifications of the charge or an impending charge through any of the notification routes available from central system 102. In a preferred form of the invention, the number of messages available for an RTU 101 may be maintained in the database maintained by database program 236 shown in FIG. 2B. The RTU data processing software 235 may periodically query this database for the number of messages available for an RTU 101. The RTU processing software 235 may also cause appropriate alarms to be sent to the RTU user to inform the user of the number of messages remaining available for the RTU.

The above described preferred embodiments are intended to illustrate the principles of the invention, but not to limit the scope of the invention. Various other embodiments and modifications to these preferred embodiments may be made by those skilled in the art without departing from the scope of the present invention.

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be closed transitional phrases, as set forth, with respect to claims, in the United States Patent Office Manual of Patent Examining Procedures (Eighth Edition, August 2001 as revised May 2004), Section 2111.03.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A remote terminal unit for a remote monitoring system, the remote terminal unit including:
(a) a substantially planar main circuit substrate on which is mounted a processor and a terminal block component;
(b) a substantially planar wireless transceiver unit;
(c) an offset interface connected between the main circuit substrate and the wireless transceiver unit to position the main circuit substrate with respect to the wireless transceiver unit so that the main circuit substrate extends along a plane substantially parallel to the plane of the wireless transceiver unit and separated from the plane of the wireless transceiver unit by an offset distance; and
(d) a battery arrangement, the battery arrangement having a major surface substantially abutting a major surface of the wireless transceiver unit and having a first end surface adjacent to an end of the main circuit substrate.

2. The apparatus of claim 1 further including a ground plane included in the offset interface, the ground plane extending parallel to the plane of the wireless transceiver unit and the plane of the main circuit substrate at a location there between.

3. The apparatus of claim 1 further including first and second connecting devices for fastening the wireless transceiver unit to the main circuit substrate with the offset interface sandwiched there between, the first and second connecting devices being located on opposite lateral sides of the wireless transceiver unit.

4. The apparatus of claim 1 further including an expansion header mounted on the main circuit substrate, the expansion header being operatively coupled between the processor and the terminal block component.

5. The apparatus of claim 1 further including a power supply mounted on the main circuit substrate and having an output insufficient to drive the wireless transceiver unit, and wherein the power output from the batteries is required to drive the wireless transceiver unit.

6. The apparatus of claim 1 further including a battery connector mounted on the main circuit substrate, the battery connector having a portion extending over a major surface facing away form the main circuit substrate.

7. The apparatus of claim 1 further including a first monitored input electrically coupled to an input of the power supply and to an input of a signal isolating device, and wherein the output of the power supply is connected to the signal isolating device so that the signal isolating device applies a voltage signal from the output of the power supply at the signal isolating device output as a monitored signal input to the remote terminal unit, and wherein the output of the power supply is applied to provide system power for the remote terminal unit.

8. A method of operating a remote equipment monitoring system, the method including:
(a) enabling a remote terminal unit to send or receive a predefined number of messages between the remote terminal unit and a central system;
(b) monitoring the number of messages sent or received by the remote terminal unit; and
(c) charging a user of the remote terminal unit a renewal charge in response to the remote terminal unit sending or receiving some number of messages over the predefined number of messages.

9. The method of claim 8 wherein the remote equipment monitoring system facilitates the transmission of user messages based on messages received by the central system from the remote terminal unit and wherein the method includes enabling the central system to send an unlimited number of user messages based upon a respective message received at the central system from the remote terminal unit.

10. The method of claim 8 including the step of limiting the number of remote terminal unit messages that may be sent or received by the remote terminal unit in a predefined period of time.

11. The method of claim 8 further including the step of charging the user of the remote terminal unit and enhancement charge in response to the remote control unit sending or receiving more than a predetermined number of remote terminal unit messages over a predefined period.

12. A remote monitoring and alerting system including:
(a) one or more remote terminal units, each remote terminal unit including,
(i) one or more monitored device inputs,
(ii) a standard serial communications interface,
(iii) a telemetry controller for responding to a plain text telemetry control protocol,
(iv) a configuration controller for producing a plain text configuration user interface on a separate computing device by communication over the standard serial communications interface, and
(v) a wireless communication network interface for enabling the remote terminal unit to send and receive data across a communications network;
(b) a central system including,
(i) a system interface between the central system and the communications network,
(ii) a data collection and manipulation controller for receiving, processing and storing data received from each remote terminal unit through the system interface,
(iii) a user messaging controller for transmitting user messages through the system interface to one or more user designated devices in response to a remote terminal unit message received from the remote terminal unit,
(iv) a user interface controller for providing a user interface between a user of the remote monitoring and alerting system and the central system.

13. The remote monitoring and alerting system of claim 12 wherein the central system further includes a remote terminal unit signaling controller for transmitting control signals to at least one remote terminal unit through the system interface.

14. A remote terminal unit for use in a remote monitoring and alerting system, the remote terminal unit including:
(b) a monitored input;
(c) a serial interface;
(d) a wireless transceiver;
(e) a processor operatively connected to the serial interface, the wireless transceiver, and to the monitored input, the processor for receiving a transmission dictating signal derived from a signal applied to the monitored input and for directing the wireless transceiver to transmit a remote terminal unit message in response to the transmission dictating signal, the processor also for driving a configuration interface on a standard terminal emulator in communication with the remote terminal unit through the serial interface.

15. The remote terminal unit of claim 14 wherein the processor is also for directing the wireless transceiver to transmit a respective remote terminal unit message in response to a plain text telemetry instruction received through the serial interface.

16. The remote terminal unit of claim 14 further including:
(a) a power supply device adapted to receive an AC input and produce a desired DC power output;
(b) a battery arrangement connected to supply power to the remote terminal unit; and
(c) a battery charging circuit connected between the power supply device and the battery arrangement, and
(d) wherein the power supply device does not provide sufficient power output to power the wireless transceiver during a respective remote terminal unit message transmission and the properly charged battery arrangement does provide sufficient power output to power the wireless transceiver during the respective remote terminal message transmission.

17. The remote terminal unit of claim 16 further including:
(a) a monitored AC signal input connected to an input of the power supply device; and
(b) an isolating circuit having an input connected to the monitored AC signal input and an output connected to apply the power supply device output in response to an activation level signal applied at the monitored AC signal input.

18. The remote terminal unit of claim 14 wherein the processor is mounted on a substantially planar main circuit substrate and the wireless transmitter is substantially planar in form and connected to the main circuit substrate so that the plane of the wireless transmitter is parallel to and offset from the plane of the main circuit substrate.

19. The remote terminal unit of claim 14 further including a signal conditioning component connected between the processor and the monitored input.

20. The remote terminal unit of claim 19 further including an expansion header connected to the signal conditioning component.
